(19) United States
(12) Patent Application Publication
(10) Pub. No.: US 2008/0245957 A1
(43) Pub. Date: Oct. 9, 2008

(54) TUNING AN ION IMPLANTER FOR OPTIMAL PERFORMANCE

(76) Inventors: Atul Gupta, Beverly, MA (US); Jay Scheuer, Rowley, MA (US); Daniel Distaso, Merrimac, MA (US); Antonella Cucchetti, Beverly, MA (US); William G. Callahan, Rockport, MA (US)

Correspondence Address: Scott Faber, Esq.;Varian Semiconductor Equipment Associates, Inc, 35 Dory Road, Gloucester, MA, 01930, US

(21) Appl. No.: 11/695,747

(22) Filed: Apr. 3, 2007

(51) Int. Cl. G21K 5/00; G01D 18/00

(52) U.S. Cl. 250/252.1; 250/492.3

(57) ABSTRACT

An approach that tunes an ion implanter for optimal performance is described. In one embodiment, there is a system for tuning an ion implanter having multiple beamline elements to generate an ion beam having desired beam properties. In this embodiment, the system comprises a beamline element settings controller configured to provide beamline element settings for generating the desired beam properties. A tuning model correlates the beamline element settings with beam properties. A calibration component is configured to calibrate the tuning model in response to a determination that beam properties measured from using the tuned beamline element settings differs from the determined tuned beamline element settings.

### BACKGROUND

This disclosure relates generally to ion implanters, and more specifically to using a tuning model to obtain optimal ion implanter performance.

Ion implantation is a standard technique for introducing conductivity-altering impurities into workpieces such as semiconductor wafers. In a conventional beamline ion implanter, an ion source generates a plasma from a feed gas that provides a volume of ions from which an ion beam is extracted through a set of extraction electrodes. The extracted ion beam contains a mixture of ions that are created in the plasma and is then directed into a mass selection apparatus which typically comprises an analyzer magnet and mass resolving slit. The analyzer magnet receives the ion beam after extraction and focuses the selected ion species from the beam for maximum transmission through the mass resolving slit. There may be other beamline elements to help maximize the transmission of the desired species through the analyzer magnet and mass resolving apparatus. For example, such elements may include one or more sets of quadrupole lenses.

The ion beam passing through the mass resolving slit then enters a first deceleration stage comprising multiple electrodes with defined apertures that allow the ion beam to pass through. By applying different combinations of voltage potentials to the multiple electrodes, the first deceleration stage can manipulate ion energies. A corrector magnet shapes the ion beam generated from the first deceleration stage into the appropriate ion distribution for implantation into the workpiece. In particular, the corrector magnet receives a divergent ion beam and collimates the beam. In addition, the corrector magnet filters out any ions from the beam that may have been neutralized while traveling through the beamline.

A second deceleration stage comprising a deceleration lens may be used to receive the ion beam from the corrector magnet and further manipulate the energy of the ion beam before it hits the workpiece. As the beam hits the workpiece, the ions in the beam penetrate the surface of the workpiece coming to rest beneath the surface to form a region of desired conductivity.

In semiconductor manufacturing, a beamline ion implanter often has to process many batches of workpieces based on various recipes. For batches processed with a common recipe, it is critical that the ion implanter maintain a consistent ion beam output so that it can deliver a desired dose of ions at the chosen energy and incident angle into the surface of the workpiece. Because the optimal combination of settings for beamline elements (e.g., ion source, extraction electrodes, analyzer magnet, first deceleration stage, corrector magnet, second deceleration stage, etc.) may change from setup to setup due to variations in source conditions or changes in the beamline surface conditions that arise over time, it becomes necessary to tune the ion implanter in order to deliver desired beam characteristics.

An ion implanter is generally tuned to deliver maximum ion beam current which translates into higher machine throughput. Tuning typically begins by finding previously used beamline element settings that will produce a beam output that most closely matches the maximum ion beam current desired by the operator of the implanter. Each of the beamline element settings is then sequentially changed one at a time through different sets of values until a value is found for that beam element that provides a maximum ion beam current. After all of the beam elements have been tuned to deliver maximum ion beam current, beam tuning is deemed to be complete so that the ion implanter can initiate ion implantation operations. Moreover these new settings for the beamline elements are stored for future setups.

Since each beamline element typically has several settings, an ion implanter with multiple beamline elements can have numerous combinations of settings that have to be sequentially changed and evaluated. The sequential changing and evaluating of one beamline element at a time is effectively a blind search in a vast data universe and therefore is inefficient and very time consuming. This approach also tends to ignore the interactions among the various beamline elements. For example, a change to one beamline element may necessitate a corresponding change of another different beamline element to a new value for the best performance. If these interactions are not accounted for, then it is likely that this sequential changing and evaluating of one beamline element at a time will hinder the tuning of the ion implanter.

Another limitation of this approach is that it does not take into account other beam properties that relate to the quality of the ion beam such as angular distribution, beam density distribution and beam profile uniformity. For example, it may be desirable to tune an ion implanter to other beam properties in addition to or in place of beam current in order to provide a more stable region of ion implanter operation.

Additional problems arise during the setup of an ion implanter. One common method of setting up a beamline ion implanter relies on selecting the “optimal” settings from a historical database of previous successful setups. Such a method is limited in that it can only approximate the combination of beamline settings that may be required to generate the desired beam properties and thus requires active tuning of the settings afterwards resulting in longer tune times.

A tuning methodology that can overcome these limitations is therefore desirable.

### SUMMARY

In one embodiment, there is a system for tuning an ion implanter having multiple beamline elements to generate an ion beam having desired beam properties. In this embodiment, the system comprises a beamline element settings controller configured to provide beamline element settings for generating the desired beam properties. The system further comprises a tuning model that correlates the beamline element settings with beam properties. A calibration component is configured to calibrate the tuning model in response to a determination that beam properties measured from using the tuned beamline element settings differs from the determined tuned beamline element settings.

In another embodiment, there is an ion implanter. In this embodiment, the ion implanter comprises a plurality of beamline elements and a controller configured to generate beamline element settings that attain an ion beam having desired beam properties. The controller comprises a beamline element settings controller configured to provide beamline element settings for generating the desired beam properties. The controller further comprises a tuning model that correlates the beamline element settings with beam properties. A calibration component is configured to calibrate the tuning model in response to a determination that beam properties measured from using the tuned beamline element settings differs from the determined tuned beamline element settings.

In a third embodiment, there is a method for tuning an ion implanter having multiple beamline elements to generate an ion beam having desired beam properties. In this embodiment, the method comprises determining beamline element settings that generate the desired beam properties; providing the beamline element settings to a tuning model that correlates the beamline element settings with beam properties; using the tuning model to determine tuned beamline element settings from the beamline settings that conform with the desired beam properties; and calibrating the tuning model in response to a determination that beam properties measured from using the tuned beamline element settings differs from the determined tuned beamline element settings.

### BRIEF DESCRIPTION OF THE DRAWINGS

FIG. 1 shows a schematic top view of an ion implanter according to one embodiment of the disclosure;

FIG. 2 shows a more detailed view of the controller shown in FIG. 1;

FIG. 3 shows a flow chart describing the process of building a tuning model according to one embodiment of this disclosure;

FIG. 4 shows a flow chart describing the process of tuning the ion implanter shown in FIG. 1 with a tuning model according to one embodiment of this disclosure; and

FIG. 5 shows a flow chart describing the process of recalibrating a tuning model according to one embodiment of this disclosure.

### DETAILED DESCRIPTION

Embodiments of this disclosure are directed to a technique for tuning an ion implanter having multiple beamline elements with a tuning model. The tuning model has the predictive capability to determine beamline element settings that will attain beam properties desired by the operator of the ion implanter in an expeditious manner that does not require the sequential changing and evaluating of separate settings. The tuning model takes into account the effects that a change in any one beamline element will have on beam properties as well as the change in any other beamline elements within the beamline that will be necessary to achieve the desired beam properties. By relying on multiple beamline element settings as criteria for optimizing the ion beam, the tuning model ensures a more consistent ion beam output. In addition, the tuning model also takes into account other beam properties that relate to the quality of the ion beam besides beam current such as angular distribution, beam density distribution and beam profile uniformity.

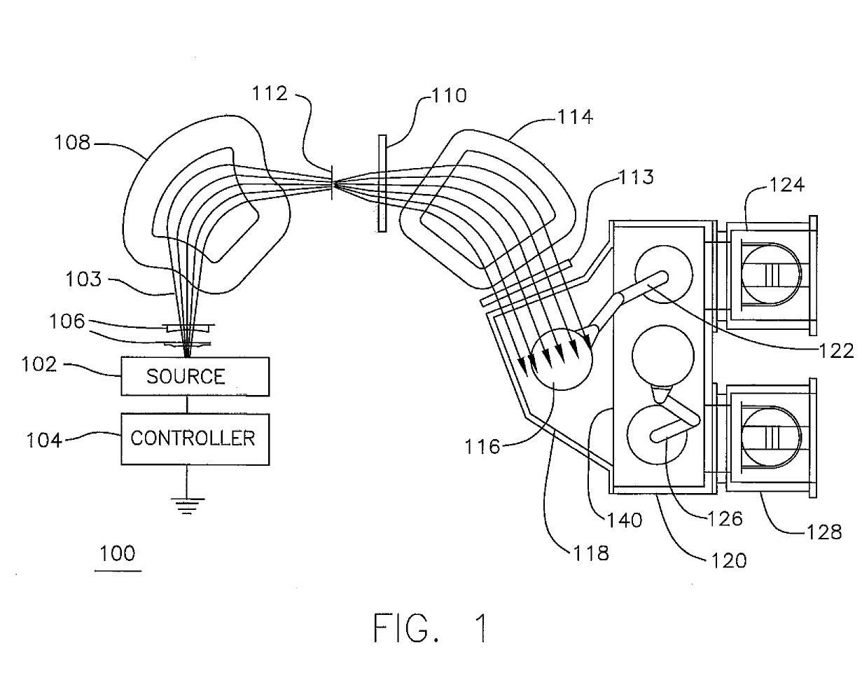

FIG. 1 shows a schematic top view of an ion implanter 100 according to one embodiment of the disclosure. The ion implanter 100 comprises an ion source 102, such as a plasma source, controlled by a controller 104. The ion source 102 generates a stream of charged particles, known as an ion beam 103. Extraction electrodes 106 receive the ion beam 103 from the ion source 102 and accelerate the positively charged ions within the beam leaving the source 102. An analyzer magnet 108, such as a 90° deflection magnet, receives the ion beam 103 after positively charged ions have been extracted from the ion source 102 and filters unwanted species from the beam for transmission through a mass resolving slit 112. In particular, as the ion beam 103 enters the analyzer magnet 108, a magnetic field directs the ion species into circular paths. Heavier ions will have larger radii of curvature and strike the outer wall of the analyzer magnet 108; lighter ions have smaller radii of curvature and will strike the inner wall of the magnet. Only ions having the needed mass to charge ratio will pass through the mass resolving slit 112.

In another embodiment, the analyzer magnet 108 may act as a focusing lens element, wherein the ion beam extracted through a slit in the source 102 passes through the analyzer magnet such that different mass ions extracted from the source have a different focal point at the plane of the mass resolving slit 112. Thus, only the desired species can pass through the opening at the mass resolving slit 112 and hence mass separation of ions is achieved.

The ion beam 103 passing through the mass resolving slit 112 then enters a first deceleration stage 110 which includes multiple electrodes (not shown) with defined apertures to allow the ion beam to pass therethrough. A corrector magnet 114, such as a 45° or a 70° corrector magnet, collimates the ion beam 103 generated from the first deceleration stage 110 into the correct form for implantation onto a workpiece 116 such as a semiconductor wafer. A second deceleration stage 113 comprising a deceleration lens can receive the ion beam 103 from the corrector magnet 114 and further manipulate the energy of the beam before it enters a vacuum chamber 118 and hits the workpiece 116.

A workpiece handling chamber 120 loads the workpiece 116 in the vacuum chamber 118 so that the workpiece can undergo the ion implantation operation. The workpiece handling chamber 120 uses a transport mechanism 122 such as a load lock to remove a workpiece from a loading cassette 124 or workpiece holder and introduces it to the vacuum chamber 118 for ion implantation. In particular, the transport mechanism 122 places the workpiece 116 in the vacuum chamber 118 in the path of the ion beam 103 such that the beam hits the workpiece, causing the ions in the beam to penetrate the surface of the workpiece and come to rest beneath the surface to subsequently form a region of desired conductivity. After completing the processing of the workpiece 116, another transport mechanism 126 transports the workpiece from the vacuum chamber 118 back to a processed cassette 128 or workpiece holder. This process of loading, processing, removing and storing workpieces continues until all of the workpieces in the loading cassette have undergone the ion implantation operation.

For ease of illustration, FIG. 1 only shows some of the beamline elements of the ion implanter 100 to facilitate a general understanding of the tuning approach described in the disclosure which is provided by the controller 104. Those skilled in the art will recognize that the ion implanter 100 can have additional components not shown in FIG. 1. Furthermore, those skilled in the art will recognize that the tuning approach described herein is suitable for any type of ion implanter such as a high current implanter, a medium current implanter or a high energy implanter. The individual elements may change between these different implanters but the tuning approach described herein is still generally applicable.

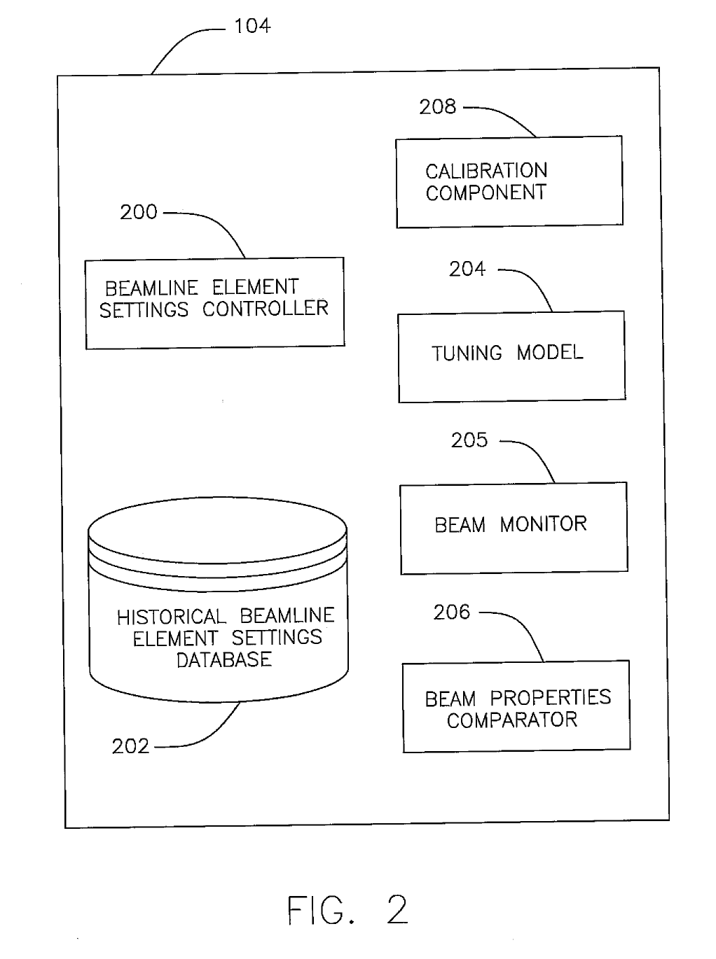

FIG. 2 shows a more detailed view of the controller 104 shown in FIG. 1. The controller 104 comprises a beamline element settings controller 200 configured to provide beamline element settings for generating the desired beam properties. The beamline settings controller has the capability to interface with the hardware and controls the operation of the hardware settings. In one embodiment, the beamline element settings controller 200 selects initial beamline element settings from a historical database 202. The historical database comprises a number of entries that include combinations of settings for the beamline elements as applied in past beam setups. Typically, each entry has been compiled by receiving input data from various sources such as a recipe generator, a beam setup report, and an ion implant report. Those skilled in the art will recognize that the historical data can be placed and organized in other types of data storage modalities besides a database such as a table, list, repository, etc.

In response to achieving the beam properties desired by the operator of the ion implanter 100, the beamline element settings controller 200 selects initial beamline element settings from the historical database 202 that can produce a beam output that most closely matches the desired properties. In one embodiment, the beam properties are beam quality metrics comprising beam current, angular distribution, beam density distribution and beam profile uniformity. Those skilled in the art will recognize that these beam quality metrics are only illustrative of some beam properties that an operator may wish to tune the ion implanter 100 to and are not meant to be limiting. For example, one of ordinary skill in the art may be interested in other beam quality metrics such as beam neutralization that can result in charging damage on the devices, or dose rate which is related to the localized beam density that may affect the residual damage distribution in the workpiece as a result of implantation.

In FIG. 2, there is a tuning model 204 that correlates the beamline element settings with beam properties. In particular, the tuning model 204 provides the capability to determine the effect of a change to one or more of the initial beamline element settings on any of the desired beam properties as well as the beamline element settings. As a result, the tuning model 204 is configured to predict, calculate or determine and generate tuned beamline element settings from the initial beamline settings that match the desired beam properties. In one embodiment, the tuning model is a statistical model however those skilled in the art will recognize that other types of models can be such as a physical/analytical model.

The beamline element settings controller 200 sets the beamline elements in accordance with the tuned beamline element settings calculated by the tuning model 204. A beam monitor 205 receives signals indicative of the beam properties from measurements taken by sensors (not shown in figures) located about the various beamline elements. An illustrative but non-exhaustive listing of sensors could include power system readbacks (i.e., voltage and current), magnetic and electrostatic field monitors, optical sensors, beam angle distribution monitor, plasma potential monitor, beamline health monitor (e.g., quartz crystal microbalance), resistivity sensor, thermocouple, etc. A beam properties comparator 206 receives the measurements from the sensors and compares the measured beam properties with the beam properties desired by the user. If the measured beam properties conform (e.g., match or are within a predetermined amount of error) to the desired beam properties, then the beamline element settings controller 200 applies these tuned settings to the beamline elements so that the ion implanter 100 can start ion implantation operations.

If the beam properties comparator 206 determines that the measured beam properties do not match beam properties calculated by the tuning model 204, then a calibration component 208 is activated to calibrate the tuning model. In particular, the calibration component 208 calibrates the tuning model 204 by receiving the measured beam properties and feeding them back into the model. The tuning model 204 is then updated with the measured beam property values. After the tuning model 204 has been calibrated, the initial beam element settings are applied and the model is used again to calculate or determine beamline element settings that can meet the desired beam properties. If these calculated beamline element settings match or are within a predetermined amount of error of the measured beam properties then the ion implanter uses these settings in the ion implantation. If not, the calibration component 208 is invoked again until suitable settings are determined. Below is a more detailed description of the calibration of the tuning model performed by the calibration component 208.

The controller 104 can take the form of an entirely hardware embodiment, an entirely software embodiment or an embodiment containing both hardware and software elements. In a preferred embodiment, the processing functions performed by the controller 104 are implemented in software, which includes but is not limited to firmware, resident software, microcode, etc.

Furthermore, the processing functions performed by the controller 104 which are described below in more detail, can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the computer, instruction execution system, apparatus, or device. The computer readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include a compact disk—read only memory (CD-ROM), a compact disk—read/write (CD-R/W) and a digital video disc (DVD).

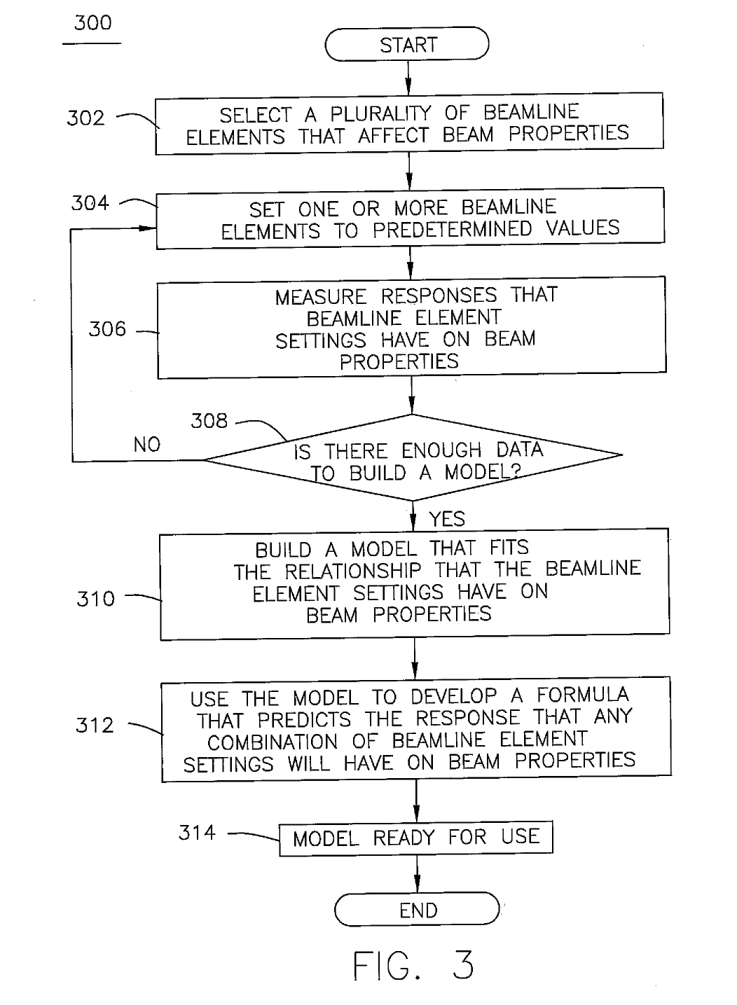

FIG. 3 shows a flow chart 300 describing the process of building the tuning model 204 according to one embodiment of this disclosure. The building of the tuning model 204 begins at 302 by selecting beamline elements that are known to affect beam properties. As those skilled in the art will recognize that there are many beamline elements that may affect beam properties such as beam current, angular distribution, beam density distribution and beam profile uniformity. An illustrative but non-exhaustive listing of some beamline elements that may affect beam properties include source electrode geometry and settings, source manipulator, quadrupole lens settings, source bias voltage, decel ratio, decel suppression bias, collimator settings, source gas flow, beamline bleed gas flow, etc.

After selecting the beamline elements, the beamline element settings controller 200 retrieves beamline element settings from the historical database 202 that have been used in past beam setups. The beamline element settings controller 200 then sets the beamline elements at 304 to the values retrieved from the historical database. Measurements indicative of the responses that these settings have on beam properties are taken from the sensors located about the various beamline elements at 306. At 308, a determination is made as to whether there is enough data to build the tuning model 204.

If it is determined at decision block 308 that there is not enough data to build the tuning model, then more data is retrieved from the historical database 202 and blocks 304 and 306 are repeated until there is enough data to build the model. Alternatively, if there is enough data to build the model then the process continues to processing block 310 where a model is built that fits the relationship that the beamline element settings have on the beam properties. In particular, the beamline element settings also referred to as factors are linearized if possible to reduce the number of measurements. A linear model that relates the response(s) to the factors thus requires sufficient number of measurements to be able to determine the coefficients.

In one embodiment, a linear model can be built with a given number (N) of independent factors, uses N+1 measurements as in the Plackett-Burman design which is well known to those skilled in the art. Those skilled in the art will recognize that there are several other well known methods for choosing the values of the parameters to build other models, e.g., Full factorial design, screening or half factorial design or other response surface designs that may be used to calculate even higher order terms in a transform matrix that relates the parameter values to each of the measured responses. In matrix representation this is listed as [R]=[T].[X] where [R] is the matrix of responses and [X] is the matrix of factors.

The tuning model may essentially be treated as a formula or a transform matrix at 312 that predicts the response that any combination of beamline element settings will have on beam properties. In other words, a given input of beamline settings is transformed into an output that comprises the beam properties. The formula may be derived through a statistical relation between the parameters or alternatively, there could be a theoretical model based on the ion beam physics that utilizes a combination of the parameters to predict the response(s) for a combination of settings. Such theory based models may require the calculations of coefficients that are intrinsic to the model which in turn may need to be verified for any particular system at least once or may need to be recalculated as part of the calibration procedures if the model predictions do not match the measured observations. This approach may be applied to the entire implanter or to specific subsystems. For example some beamline elements are easily described by a theoretical model e.g., corrector magnet settings etc., while there may be others that are too complex to derive a theoretical model and thus are more likely to be expressed as a statistics based model. A combination of these two model types for different components may also be used to have an overall model for the entire implanter system and different types of calibrations measurements may need to be performed for these different subsystem components depending on what models are to be calibrated for that specific subsystem. The tuning model is then ready for use at 314 to predict or calculate beam line element settings that attain the beam properties desired by the operator of the ion implanter.

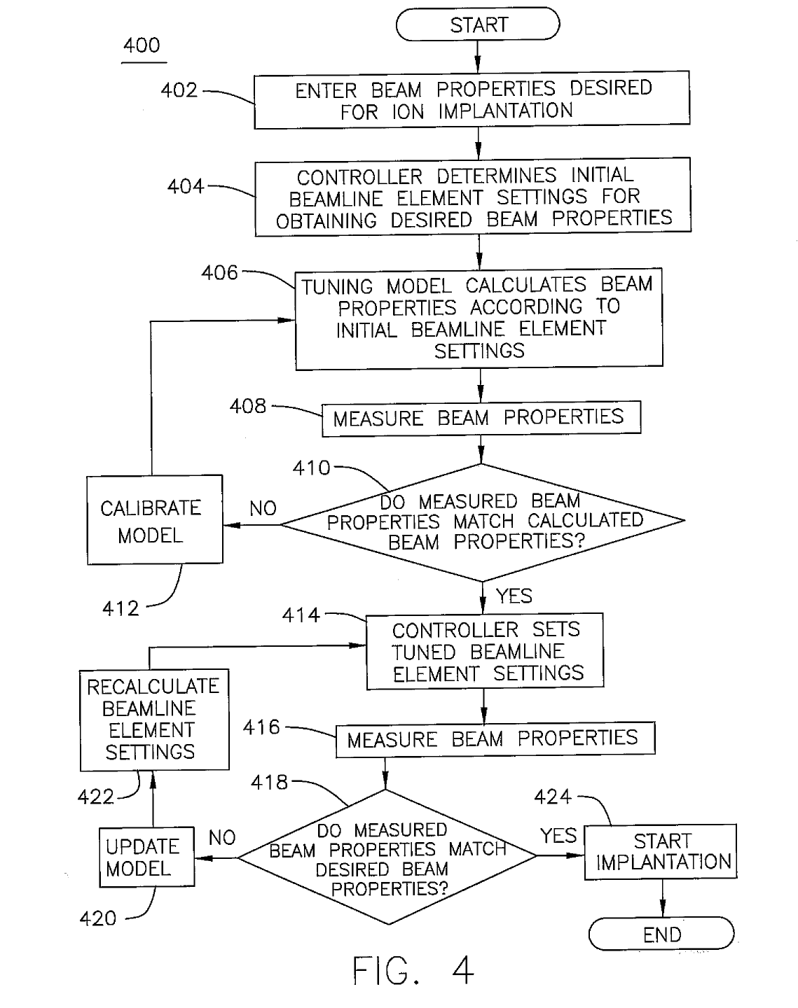

FIG. 4 shows a flow chart 400 describing the process of tuning of the ion implanter 100 shown in FIG. 1 with the tuning model 204. The tuning of the ion implanter begins at 402 where the operator enters the beam properties that he or she desires for the ion implantation. The beam properties as mentioned above are beam quality metrics that can include beam current, angular distribution, beam density distribution and beam profile uniformity. As an example, if the operator was interested in attaining beam current and beam profile uniformity, then it might be desirable to have the maximum beam current and beam profile uniformity (1 sigma) better than 1% as well as beam angle spread better than 1°.

After the operator has entered the desired criteria for the beam properties, the beamline element settings controller 200 then selects the initial beamline element settings from the historical database 202 at 404. As mentioned above, the initial beamline element settings are values that can produce a beam output that most closely matches the desired beam properties. The tuning model 204 receives the initial beamline element settings and the desired beam properties and calculates settings that will attain the desired properties at 406. In particular, the tuning model 204 generates tuned beamline element settings from the initial beamline element settings that will match the desired beam.

The beamline element settings controller 200 then sets the beamline elements in accordance with the tuned beamline element settings calculated by the tuning model 204. Measurements indicative of the beam properties are taken from the sensors located about the various beamline elements and received by the beam monitor 205 at 408. Some of such sensor signals may comprise but are not limited to power supply signals such as current or voltage readbacks, magnetic field, electrostatic field, beam shape, beam density, beam deposits, time from last maintenance, temperature of different components, etc.

The beam properties comparator 206 receives the measurements from the beam monitor 205 and compares the measured beam properties with the calculated beam properties at 410. If the measured beam properties do not match or are not within a predetermined amount of error with the calculated beam properties, then the calibration component 200 is activated at 412 to calibrate the tuning model 204. After the tuning model 204 has been calibrated, then the model calculates the beam properties at 406 and measurements of the beam properties are taken from the sensors are taken at 408. This iteration continues until the measured beam properties match or are within a predetermined error with the calculated beam properties as determined at decision block 410.

If the measured beam properties match or are within a predetermined amount of error with the calculated beam properties, then the beamline element settings controller 200 sets the beamline elements to these tuned settings at 414. Measurements of the beam properties are again taken from the sensors and received by the beam monitor at 416. At decision block 418, the beam properties comparator 206 determines if the measured beam properties match the desired beam properties. If the measured beam properties do not match the desired beam properties, then the tuning model 204 is updated with the measured beam properties at 420 wherein at least one or more of the coefficients in the transform matrix that relate the settings to the measured response is recalculated or adjusted. After updating the tuning model, then the beamline element settings are recalculated at 422.

The controller then sets the tune beamline element settings at 414. Measurements of the beam properties are taken from the sensors and received by the beam monitor at 416. The beam properties comparator again compares the measured beam properties to the desired beam properties at 418. This iteration of blocks 414-422 continues until the measured properties match the desired beam properties or are within a predetermined amount of error. Once the measured properties match the desired beam properties then ion implanter 100 can begin the ion implantation at 424.

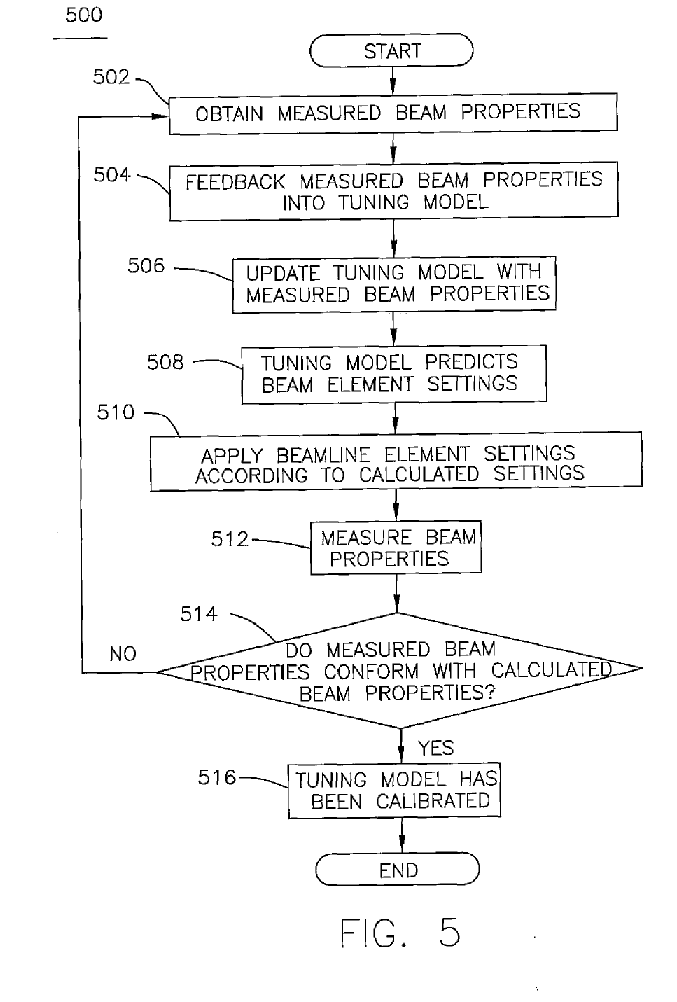

FIG. 5 shows a flow chart 500 describing the process of calibrating a tuning model according to one embodiment of this disclosure. The calibration component 208 begins the calibration process by receiving the measured beam properties obtained from the sensors at 502. The calibration component 208 then feeds back the measured properties into the model at 504. The tuning model 206 is then updated with the measured property values at 506 wherein at least one or more of the coefficients in the transform matrix that relate the settings to the measured responses is recalculated or adjusted based on the new observations. After updating the tuning model, it is used to calculate the beam element settings at 508. Afterwards, the beam elements are set to the calculated beam element settings at 510.

Measurements indicative of the beam properties are taken again from the sensors located about the various beamline elements and received by the beam monitor at 512. The beam properties comparator 206 receives the measurements from the sensors and compares the measured beam properties with the calculated beam properties determined by the tuning model at 514.

If the measured beam properties match or are within a predetermined amount of error of the calculated beam properties, then the tuning model is considered calibrated at 516 and is therefore ready for use with the ion implanter 100. Alternatively, if the measured beam properties do not match the calculated beam properties, then the calibration component 208 is invoked again and process acts 502-514 are repeated until suitable settings are predicted.

The foregoing flow charts shows some of the processing functions associated with building a tuning model, using the model with an ion implanter and calibrating the model. In this regard, each block represents a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe the processing functions may be added.

It is apparent that there has been provided with this disclosure an approach for tuning an ion implanter for optimal performance. While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A system for tuning an ion implanter having multiple beamline elements to generate an ion beam having desired beam properties, comprising:
a beamline element settings controller configured to provide beamline element settings for generating the desired beam properties;
a tuning model that correlates the beamline element settings with beam properties; and
a calibration component configured to calibrate the tuning model in response to a determination that beam properties measured from using the tuned beamline element settings differs from the determined tuned beamline element settings.

2. The system according to claim 1, further comprising a historical database containing a plurality of a beamline element settings and corresponding beam properties.

3. The system according to claim 2, wherein the beamline element settings controller is configured to provide the beamline element settings by selecting beamline element settings from the historical database that can produce a beam output that most closely matches the desired beam properties.

4. The system according to claim 1, wherein the beamline element settings controller is configured to set the beamline elements in accordance with the tuned beamline element settings.

5. The system according to claim 1, further comprising a beam property monitor configured to receive beam property measurements from one or more sensors located about the beamline.

6. The system according to claim 5, wherein the beam property measurements from the one or more sensors comprises current readbacks, voltage readbacks, magnetic field, beam deposits and temperature.

7. The system according to claim 1, further comprising a beam properties comparator configured to compare beam properties measured from using the tuned beamline element settings with the desired beam properties.

8. The system according to claim 1, wherein the calibration component is configured to calibrate the tuning model in accordance with the measured beam properties.

9. The system according to claim 1, wherein the calibrated tuning model is configured to generate tuned beamline element settings that match the desired beam properties.

10. The system according to claim 1, wherein the desired beam properties are beam quality metrics comprising at least one of beam current, angular distribution, beam density distribution or beam profile uniformity.

11. An ion implanter, comprising:
a plurality of beamline elements; and
a controller configured to generate beamline element settings that attain an ion beam having desired beam properties, the controller comprising a beamline element settings controller configured to provide beamline element settings for generating the desired beam properties; a tuning model that correlates the beamline element settings with beam properties; and a calibration component configured to calibrate the tuning model in response to a determination that beam properties measured from using the tuned beamline element settings differs from the determined tuned beamline element settings.

12. The ion implanter according to claim 11, wherein the controller comprises a historical database containing a plurality of a beamline element settings and corresponding beam properties.

13. The ion implanter according to claim 12, wherein the beamline element settings controller is configured to provide the beamline element settings by selecting beamline element settings from the historical database that can produce a beam output that most closely matches the desired beam properties.

14. The ion implanter according to claim 11, wherein the beamline element settings controller is configured to set the beamline elements in accordance with the tuned beamline element settings.

15. The ion implanter according to claim 11, further comprising a beam property monitor configured to receive beam property measurements from one or more sensors located about the beamline.

16. The ion implanter according to claim 11, further comprising a beam properties comparator configured to compare beam properties measured from using the tuned beamline element settings with the desired beam properties.

17. The ion implanter according to claim 11, wherein the calibration component is configured to calibrate the tuning model in accordance with the measured beam properties.

18. The ion implanter according to claim 11, wherein the calibrated tuning model is configured to generate tuned beamline element settings that match the desired beam properties.

19. The ion implanter according to claim 11, wherein the desired beam properties are beam quality metrics comprising at least one of beam current, angular distribution, beam density distribution or beam profile uniformity.

20. A method for tuning an ion implanter having multiple beamline elements to generate an ion beam having desired beam properties, comprising:
determining beamline element settings that generate the desired beam properties;
providing the beamline element settings to a tuning model that correlates the beamline element settings with beam properties;
using the tuning model to determine tuned beamline element settings from the beamline settings that conform with the desired beam properties; and
calibrating the tuning model in response to a determination that beam properties measured from using the tuned beamline element settings differs from the determined tuned beamline element settings.

21. The method according to claim 20, wherein the determining of beamline element settings comprises selecting from historical beamline element settings, wherein the selected beamline element settings are representative of settings that can produce a beam output that most closely matches the desired beam properties.

22. The method according to claim 20, further comprising setting beamline elements in accordance with the determined tuned beamline element settings.

23. The method according to claim 20, further comprising monitoring beam property measurements from one or more sensors located about the beamline.

24. The method according to claim 20, further comprising comparing beam properties measured with the tuned beamline element settings with the desired beam properties.

25. The method according to claim 20, wherein the calibrating of the tuning model comprises calibrating the tuning model in accordance with the measured beam properties.

26. The method according to claim 20, wherein the calibrating of the tuning model comprises generating tuned beamline element settings that match the desired beam properties.

27. The method according to claim 20, wherein the desired beam properties are beam quality metrics comprising at least one of beam current, angular distribution, beam density distribution or beam profile uniformity.

28. A computer-readable medium storing computer instructions, which when executed, enables a computer system to perform the method receited in claim 20.
